(19) United States
(12) Patent Application Publication
(10) Pub. No.: US 2007/0030240 A1
(43) Pub. Date: Feb. 8, 2007

(54) Display device, method, and terminal device having switchable viewing angle

(75) Inventors: Ken Sumiyoshi, Tokyo (JP); Koji Mimura, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignees: NEC Corporation; NEC LCD Technologies, Ltd.

(21) Appl. No.: 11/461,979

(22) Filed: Aug. 2, 2006

(30) Foreign Application Priority Data
Aug. 5, 2005 (JP) 2005-228907

(51) Int. Cl. G09G 3/36

(52) U.S. Cl. 345/102

(57) ABSTRACT

After light from a planar light source is switched to scattered light or collimated light by a switching element, the light is incident on a display panel, and an image is displayed. At this time, the luminance of the planar light source is adjusted, the contrast voltage of the display panel is reset, and adjustment is performed so that the luminance and hue of the frontal image does not vary before and after switching.

### BACKGROUND OF THE INVENTION

1. Field of the Invention

The present invention relates to a display device, method, and terminal device having a switchable viewing angle that are capable of switching between a narrow-angle mode and a wide-angle mode to be able to switch the range of viewable angles.

2. Description of the Related Art

There has been a recent demand for security features in a display device that prevent viewing by persons other than the main person viewing the display device, i.e., persons in the vicinity of the display device. For example, security codes and other confidential information must be entered by touching number buttons displayed on a display device in a financial terminal or the like known as an ATM (Automated Teller Machine), and the user must avoid allowing this information to be recognized by others. A feature is also desired in a mobile telephone or the like that prevents incoming information from being seen by others nearby the main user. The same feature for preventing viewing by nearby persons is also desired in PDAs (Personal Digital Assistance: personal information terminal), notebook-type personal computers (hereinafter referred to as notebook PCs), and the like when these devices are used in trains and other public transportation facilities.

On the other hand, there is also a demand for enabling these display devices to be visible to multiple users at once. Viewing television on a mobile telephone is one example of this feature, and the owner of the mobile telephone sometimes wishes to show the display to another nearby person. The data screen of a notebook-type personal computer is also sometimes viewed by multiple users at once.

Modes in a display device therefore include a narrow-angle mode for viewing highly confidential information in personal fashion, and a wide-angle mode for viewing highly public information with a plurality of people. There is also a need for a display device that is capable of switching between these display modes in a PDA, a notebook PC, or the like.

This type of display device capable of switching between a narrow-angle mode and a wide-angle mode is proposed in Japanese Laid-Open Patent Application 9-197405. Arranged in sequence in this display device disclosed in Japanese Laid-Open Patent Application 9-197405 are a light source, a first optical element, a liquid crystal display element, and a second optical element. The directivity of light from the light source is increased by the first optical element (the light is collimated), and the light enters the liquid crystal display device. The diffusion and rectilinear propagation of light rays constituting the light exiting the liquid crystal display device are electrically controlled by the second optical element.

The operational principle of this display device will next be described. In the narrow-angle mode, the second optical element is in the transparent state. Therefore, the directivity of light emitted from the light source is increased by the first optical element, and the light enters the display panel while still in a state of high directivity. A display image is formed is a display panel by a plurality of pixels, but the directivity of the incident light is not significantly affected by this process. Therefore, an observer positioned in front of the display device can see the displayed image, but the display image does not reach an observer who is in a diagonal position from the front of the display device, and this observer cannot see the displayed image.

In the wide-angle mode, the second optical element is in a scattering state. Therefore, the light whose directivity is increased by the first optical element is scattered by the second optical element. This scattered light is incident on the display panel. Therefore, not only is the display image visible to an observer in front of the display device, but the image is also visible to an observer positioned in a diagonal direction from the display device.

Another display device capable of switching between a narrow-angle mode and a wide-angle mode is proposed in Japanese Laid-Open Patent Application 6-59287. The display device disclosed in Japanese Laid-Open Patent Application 6-59287 is a liquid crystal display device having a guest-host liquid crystal on which light from a light source is incident, and a liquid crystal cell on which the light from the guest/host liquid crystal is incident. The guest/host liquid crystal adjusts the width of the viewing angle with respect to the liquid crystal cell.

In the display device described in Japanese Laid-Open Patent Application 6-59287, the light emitted from the light source is diffused light. When the dichroic dye molecules in the guest-host liquid crystal are oriented substantially perpendicular to the substrate surface, the light that is incident in the direction normal to the substrate surface is weakly absorbed, and the light that is incident in a direction that is tilted from the direction normal to the substrate surface is strongly absorbed. The light that passes through the guest/host liquid crystal is therefore increased in directivity. Accordingly, only an observer in front of the display device can see the image, but the display image does not reach an observer who is in a diagonal position from the front of the display device, and this observer cannot see the displayed image. This condition corresponds to the narrow-angle mode.

When the dichroic dye molecules in the guest-host liquid crystal are oriented parallel to the substrate surface, it becomes possible to display an image without any additional light loss as long as the orientation of the dichroic dye molecules in the plane of the substrate matches the orientation of the absorption axis of a polarizing plate disposed on the incident side of the display panel. Since the dichroic dye molecules are then oriented parallel to the substrate surface, there is no strong absorption of light that enters at an angle. Therefore, the image can be seen not only by an observer who is in front of the display device, but also by an observer positioned at an angle from the front of the display device. This condition corresponds to the wide-angle mode.

Any of the conventional display devices described above enables control of the viewing angle range, and allows narrow-angle range/wide-angle range switching to be made.

The problems described below occur when a display device provided with the switching capability described above is put into practical use. Specifically, a first problem is that a significant change in frontal luminance occurs before and after switching. This problem will be described in Japanese Laid-Open Patent Application 9-197405 as an example. As shown in FIG. 2 of Japanese Laid-Open Patent Application 9-197405, the light that contributes to the display during the “wide-angle characteristic” is scattered light. The light that contributes to the display during the “narrow-angle characteristic” is collimated light. Therefore, the frontal luminance during the “wide-angle characteristic” decreases significantly, and the frontal luminance increases significantly during the “narrow-angle characteristic.” The luminance therefore varies significantly from before to after switching, and the image becomes extremely difficult for the user to look at.

A second problem is that a color shift occurs before and after switching. This problem will be described using Japanese Laid-Open Patent Application 9-197405 as an example. In FIG. 2 of Japanese Laid-Open Patent Application 9-197405, polymer-dispersed liquid crystal (PDLC: Polymer Dispersed Liquid Crystal) in which liquid crystal regions are dispersed in a polymer as a support medium is used as the switching element. Shorter-wavelength light is generally more easily scattered, and longer-wavelength light is relatively difficult to scatter. Therefore, the wavelength distribution of light emitted to the front varies before and after switching. Even when the guest/host liquid crystal described in Japanese Laid-Open Patent Application 6-59287 is used, the absorption spectrum changes before and after switching. The display device described in Japanese Laid-Open Patent Application 6-59287 therefore also suffers from the same problem of hue variation at the front.

As described above, switchable display devices have problems in that the state of the display significantly varies from before to after switching.

A method is disclosed in Japanese Laid-open Patent Application 2005-115021 for easily adjusting a color component in response to a change in color temperature that occurs when the luminance of the backlight is adjusted. According to the method disclosed in Japanese Laid-open Patent Application 2005-115021, at least one color component selected from among an R light source, a G light source, and a B light source of the LCD backlight is increased or reduced when the color temperature changes before and after adjusting the luminance of the backlight. However, the problems of variations in the wavelength distribution and hue during switching between a wide angle and a narrow angle are not overcome in Japanese Laid-open Patent Application 2005-115021.

### SUMMARY OF THE INVENTION

An object of the present invention is to provide a display device and method capable of switching between a narrow-angle mode and a wide-angle mode, wherein the method and the display device having a switchable viewing angle are capable of suppressing variations in luminance and hue during switching, and to provide a terminal device.

The liquid crystal display device having a switchable viewing angle according to a first aspect of the present invention comprises a planar light source for emitting light in a plane; a switching element for switching the light from the planar light source to scattered light or collimated light; a display panel for displaying an image, on which the light from the switching element is incident; and a control unit for controlling the switching element to switch between emitting scattered light or collimated light, varying the luminance of the planar light source during the switch, and adjusting the transmittance of at least a portion of the color pixels of the display panel in accordance with a variation in the luminance of the planar light source.

The liquid crystal display device according to a second aspect of the present invention comprises a planar light source for emitting light in a plane; a display panel for displaying an image, on which the light from the planar light source is incident; a switching element for switching the light from the display panel to scattered light or collimated light; and a control unit for controlling the switching element to switch between emitting scattered light or collimated light, varying the luminance of the planar light source during the switch, and adjusting the transmittance of at least a portion of the color pixels of the display panel in accordance with a variation in the luminance of the planar light source.

In such a liquid crystal display device having a switchable viewing angle, the switching element is a polymer-dispersed liquid crystal or guest/host liquid crystal, for example. It is also preferred that the directivity of the light from the light source be increased by a linear louver. The color pixels for adjusting the transmittance are blue pixels, for example. Alternatively, the color pixels for adjusting the transmittance are pixels of all colors, including blue, red, and green. Furthermore, the luminance of the planar light source may be varied by varying the amount of electric current applied to the planar light source, or by time modulation of the current fed to the planar light source.

The method for switching the viewing angle of a liquid crystal display according to the present invention comprises switching between wide-angle display and narrow-angle display by switching light from a planar light source or light from a display panel to scattered light or collimated light with the aid of a switching element when an image is displayed using light from the planar light source incident on the display panel, wherein the method for switching the viewing angle of a liquid crystal display comprises varying the luminance of the planar light source during switching by the switching element; adjusting the transmittance of at least a portion of the color pixels of the display panel in accordance with a variation in the luminance of the planar light source; and performing control so that the variation in the luminance and hue does not occur before and after the switching.

In this method for switching the viewing angle of a liquid crystal display, the switching element may be switched to scattered light or collimated light by switching between a transparent state and a scattering state, switching between a high-reflection state and a low-reflection state, or switching between a high-absorption state and a low-absorption state.

The terminal device according to the present invention is provided with the liquid crystal liquid crystal display device having a switchable viewing angle according to any of the aspects described above.

The present invention makes it possible to suppress variations in the luminance and hue of a displayed image during switching between a wide viewing angle and a narrow viewing angle.

### BRIEF DESCRIPTION OF THE DRAWINGS

FIG. 1 is a view of a first embodiment of the present invention;

FIG. 2 is a diagram depicting the contrast setting of the display panel of the present embodiment;

FIG. 3 is a diagram depicting a change in the chromaticity coordinates of an LED element;

FIG. 4 is a view of a second embodiment of the present invention;

FIG. 5 is a view of a third embodiment of the present invention;

FIG. 6 is a sectional view of the structure of the same embodiment;

FIG. 7 is a diagram showing the manner in which the chromaticity coordinates change when a voltage is continuously applied to polymer-dispersed liquid crystal;

FIG. 8 is a diagram showing a change in the chromaticity coordinates of the transmittance of the layered structure (planar light source, linear louver, and switching element); and

FIG. 9 is a diagram depicting the contrast setting of the display panel in the present embodiment.

### DESCRIPTION OF THE PREFERRED EMBODIMENTS

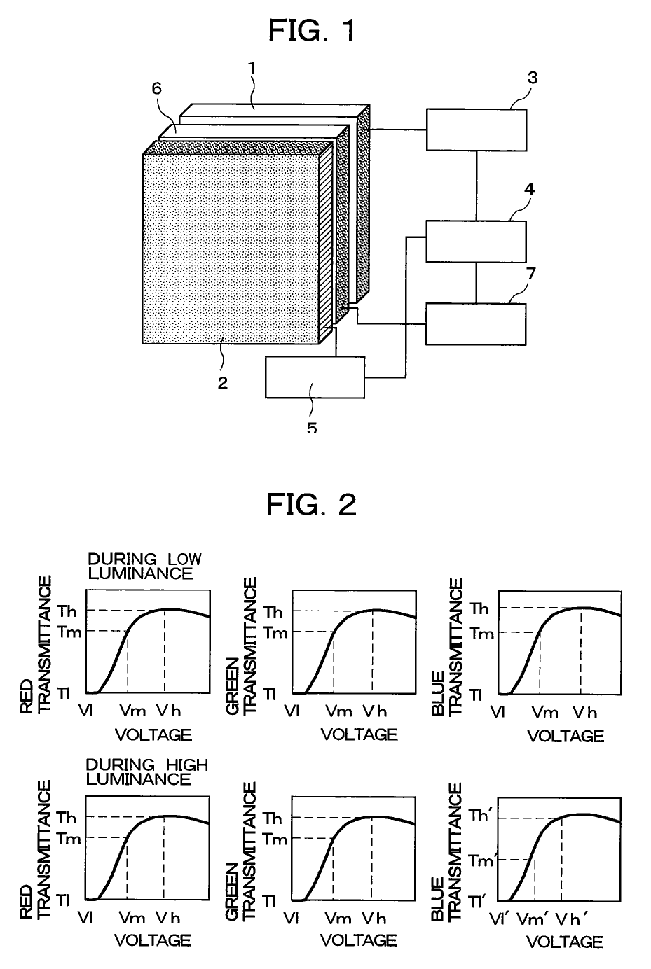

Embodiments of the present invention will be described in detail hereinafter with reference to the accompanying drawings. FIG. 1 is a view of the liquid crystal display device having a switchable viewing angle according to an embodiment of the present invention. Planar light is emitted from a planar light source 1 as a backlight, and the planar light enters a liquid crystal display panel 2 via a switching element 6.

The planar light source 1 may be a bottom-lighting planar light source or a side-lighting planar light source. A bottom-lighting planar light source is composed of a light source and a diffusion panel disposed above the light source. A side-lighting planar light source is composed of an optical waveguide and a light source disposed to the side of the optical waveguide. In either of these cases, the luminance of the planar light source varies according to the amount of luminous flux of the light source. The luminance of the planar light source 1 is adjusted by a light source control unit 3.

The switching element 6 switches between a wide viewing angle and a narrow viewing angle. Examples of this type of switching element 6 include the guest/host liquid crystal disclosed in Japanese Laid-Open Patent Application 6-59287 and the PDLC disclosed in Japanese Laid-Open Patent Application 9-197405. In the case of a guest/host liquid crystal, liquid crystal molecules and dichroic dye molecules are included in liquid crystal material held between two transparent substrates. When a voltage is not applied via transparent electrodes provided to the transparent substrates, the optical axis (major axis) of the dichroic dye molecules is substantially parallel to the surface of the transparent substrates. In contrast, when a voltage is applied across the transparent electrodes, the dichroic dye molecules stand perpendicular to the substrate surface, and light having an optical axis other than the optical axis of the dichroic dye molecules is absorbed by the dichroic dye molecules and is prevented from passing through the guest/host liquid crystal. A wide-angle view and a narrow-angle view can thereby be switched according to whether a voltage is applied to the guest/host liquid crystal, or by adjusting the applied voltage. In the case of a PDLC, a liquid crystal layer held in a pair of transparent substrates has liquid crystal regions dispersed in a polymer support medium. The PDLC becomes transparent when a voltage is applied to transparent electrodes provided to the transparent substrates, and the PDLC changes to a scattering state when a voltage is not applied. The range of viewable angles can thus be switched between a wide viewing angle and a narrow viewing angle using either type of switching element 6. The switching of this switching element 6 between a wide viewing angle and a narrow viewing angle is controlled by a switching element control unit 7.

The display panel 2 is a transmissive liquid crystal display element, and the transmittance of the color pixels of the display panel 2 is controlled by a display control unit 5.

A control unit 4 outputs a control signal to the light source control unit 3 to adjust the luminance of the planar light source 1, and outputs a control signal to the display control unit 5 to adjust the display signal presented to the display panel 2.

The operation of the liquid crystal display device having a switchable viewing angle configured as described above will next be described. FIG. 2 is a transmittance diagram of the contrast level of each color of pixels when the planar light source 1 is an LED (Light Emitting Diode) light source. Transmittance graphs for the red, green, and blue of a low-luminance light source are shown at the top of FIG. 2, and the same graphs for a high-luminance light source are shown at the bottom of FIG. 2. As typical contrast levels in FIG. 2, Th indicates the transmittance of high contrast levels, Tm indicates the middle-contrast transmittance, and Tl indicates the low-contrast transmittance, and Vh, Vm, and Vl are the respective set voltages.

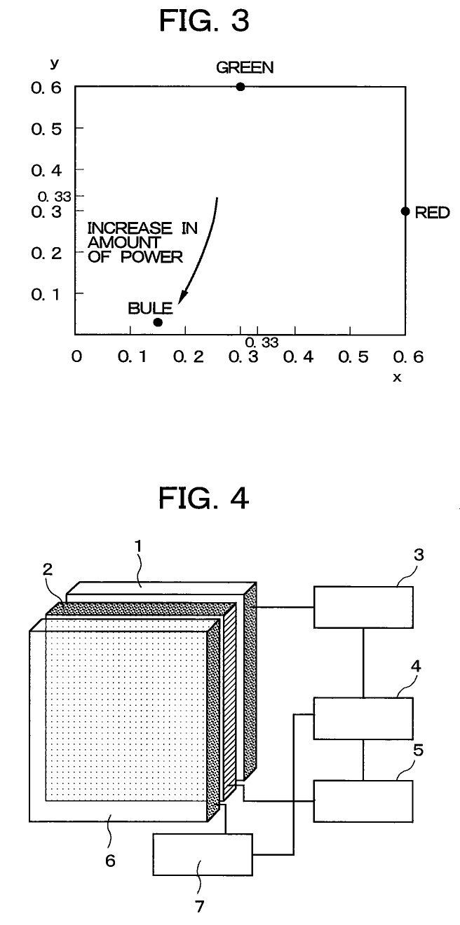

The emission spectrum of the light source varies slightly according to the amount of current applied. FIG. 3 shows the variation of the chromaticity coordinates (x, y) according to the amount of electrical power when white LED light, for example, is used. As shown in FIG. 3, there is an apparent shift towards the blue chromaticity coordinate as the amount of power is increased, and the ratio of blue emission increases.

In view of the above, in the present invention, the contrast-setting voltage during high luminance is changed and reset as shown at the bottom of FIG. 2 in relation to the contrast-setting voltage during low luminance. In order to simplify the description, FIG. 2 shows a state in which only the set voltage for blue transmittance is varied. As previously mentioned, since the blue emission ratio of the LED increases during high luminance, the contrast-setting voltage during high luminance is reset as shown at the bottom of FIG. 2. Therefore, during high luminance, the high-contrast transmittance of blue is reset to Th′, and the middle-contrast transmittance is reset to Tm′. As a result, the blue emission ratio of the LED of the planar light source 1 increases when the luminance is high, but the transmittance of blue pixels is set low. Therefore, there is no variation in the hue of the image displayed by the display panel 2.

In the present embodiment, the control unit 4 first transmits a signal to the switching element control unit 7 for switching to a wide viewing angle, and sets the switching element 6 to a wide viewing angle when the image displayed by the display panel 2 is displayed with a wide viewing angle. Specifically, the switching element 6 is placed in a state whereby scattered light is emitted to the display panel 2. In other words, the light that contributes to the display is scattered light in the case of a wide viewing angle, and the light that contributes to the display is collimated light in the case of a narrow viewing angle. Therefore, the frontal luminance significantly decreases in the case of a wide viewing angle, and significantly increases in the case of a narrow viewing angle. When the switching element 6 is a PDLC, shorter-wavelength light is more easily scattered, and longer-wavelength light is more difficult to scatter. Therefore, the wavelength distribution of light emitted to the front varies when switching to a wide viewing angle. Even when the switching element 6 is a guest/host liquid crystal, the absorption spectrum varies when switching to a wide viewing angle. The luminance and hue thus vary when the switching element 6 is switched to a wide viewing angle.

In view of the above, in the present embodiment, a control signal is outputted to the light source control unit 3, and the luminance of the planar light source 1 is increased by the light source control unit 3 when the control unit 4 switches the switching element 6 to the wide viewing angle via the switching element control unit 7. As previously mentioned, the emission ratio of blue in the planar light source 1 increases, and the wavelength distribution of the light emitted from the switching element 6 varies when the luminance is high. Accordingly, the control unit 4 outputs a control signal to the display control unit 5 to adjust the transmittance of each color of pixels of the display panel 2 and to cause the transmission spectrum of the light emitted from the display panel 2 to conform to its state prior to switching. Specifically, the contrast voltage is reset so that the contrast-setting voltage for low luminance changes to the contrast-setting voltage for high luminance, and the increase in the transmittance of blue that accompanies high luminance is overcome, as shown in FIG. 2. The contrast voltage is reset so as to overcome the variation in the wavelength distribution of emitted light in the switching element 6.

The converse operation is performed when the switching element 6 is switched from a wide viewing angle to a narrow viewing angle. In this case, the light source control unit 3 controls the planar light source 1 so that the luminance of the planar light source 1 decreases, and resets the transmittance of each color of pixels in the planar light source 1 as shown at the top of FIG. 2. Placing the switching element 6 in a collimating state, rather than a scattering state, brings about a change in the spectrum of the light emitted from the switching element 6. Therefore, the transmittance of the display panel 2 is adjusted in order to overcome this spectrum variation.

The image displayed by the display panel 2 is thereby prevented from changing and becoming difficult to view due to variation in luminance and hue before and after switching between a wide viewing angle and a narrow viewing angle.

The control unit 4, the light source control unit 3, the switching element control unit 7, and the display control unit 5 may also be composed of software instead of circuits each of which has a separate function. A liquid crystal element having a reflective polarizing plate may be used as the switching element. In this case, the switching element may assume a high reflecting state or a low reflecting state. Furthermore, a polymer network liquid crystal, capsule-type liquid crystal, or other scattering liquid crystal element may be used as the switching element.

The liquid crystal display device having a switchable viewing angle may be mounted in a mobile telephone or other terminal device.

A second embodiment of the present invention will next be described with reference to FIG. 4. The present embodiment differs from the embodiment shown in FIG. 1 in that the liquid crystal display panel 2 is disposed on the planar light source 1, and the switching element 6 is disposed on the liquid crystal display panel 2. The structure of the planar light source 1, the liquid crystal display panel 2, and the switching element 6 is the same as in the embodiment shown in FIG. 1. The structure of the control unit 4, the light source control unit 3, the display control unit 5, and the switching element control unit 7 is also the same as in the embodiment shown in FIG. 1.

In the present embodiment, the control unit 4 controls the switching element 6 by means of the switching element control unit 7, and the luminance of the image displayed by the liquid crystal display device is prevented from varying during switching between a wide viewing angle and a narrow viewing angle by controlling the planar light source 1 through the light source control unit 3 so as to vary the luminance of the planar light source 1. The blue emission ratio of the planar light source 1 is prevented from increasing and changing the hue when the luminance is high, and the wavelength distribution is prevented from varying according to the transparent or scattering state of the switching element 6. This is achieved by resetting the contrast-setting voltage of the liquid crystal display panel 2. The present embodiment thereby demonstrates the same effects as the first embodiment.

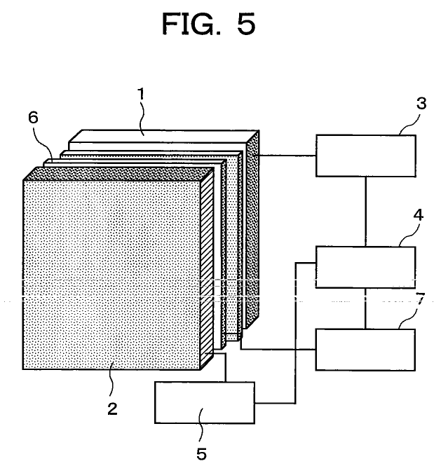

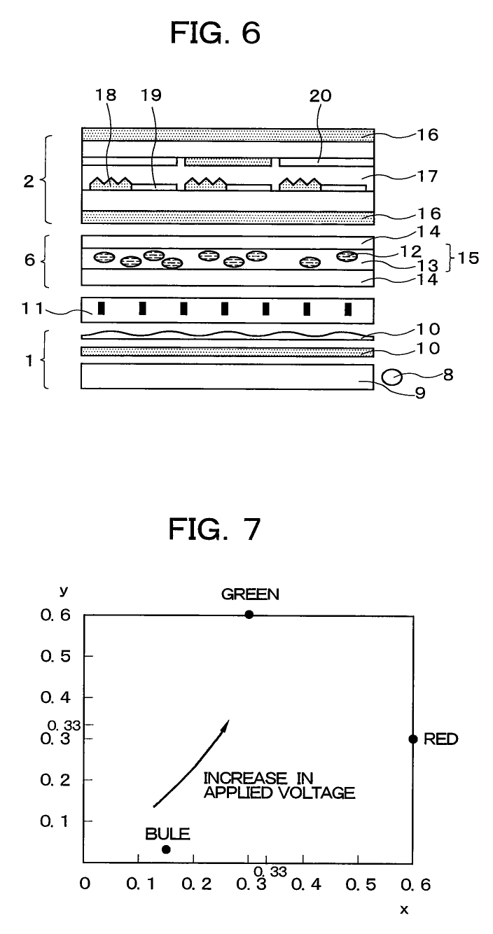

A third embodiment of the present invention will next be described. FIG. 5 shows the liquid crystal display device having a switchable viewing angle according to the present embodiment, and FIG. 6 is a sectional view showing the structure of the same. In the present embodiment, a linear louver 11 is disposed on the planar light source 1, the switching element 6 is disposed on the linear louver 11, and the display panel 2 is furthermore disposed on the switching element 6. The luminance of the planar light source 1 is controlled by the light source control unit 3, and the switching element control unit 7 controls the scattering state, transparent state, or other state of the switching element 6 to obtain a wide viewing angle or a narrow viewing angle. The transmittance of each color in the liquid crystal display panel 2 is controlled by the display control unit 5. The control unit 4 controls the light source control unit 3, the switching element control unit 7, and the display control unit 5.

As shown in FIG. 6, the planar light source 1 is, for example, a side-lighting LED light source; a prism sheet 10 is provided on an optical waveguide 9; and a white LED 8 is provided to the side portion of the optical waveguide 9. A blue LED chip on which yellow phosphors are placed, an ultraviolet LED on which white phosphors are placed, or the like may be used as the white LED 8. The optical waveguide 9 emits as planar light the light incident from the white LED 8. The prism sheet 10 increases the directivity of the light emitted from the optical waveguide 9. The linear louver 11 further increases the directivity of the light from the planar light source 1.

Light having increased directivity thus enters the switching element 6. In the switching element 6, a polymer-dispersed liquid crystal (PDLC) 15 is held between a pair of plastic substrates 14, and liquid crystal regions 12 are dispersed in a polymer support medium 13 in the polymer-dispersed liquid crystal 15. Applying a voltage across transparent electrodes provided to the plastic substrates 14 places the polymer-dispersed liquid crystal 15 in a transparent state, and not applying a voltage places the polymer-dispersed liquid crystal 15 in a scattering state. The switching element 6 is not limited to being a polymer-dispersed liquid crystal 15, and may be any element that can be switched between a transparent state and a scattering state. A transmissive liquid crystal display panel or a transflective liquid crystal display panel may be used as the display panel 2. The display panel 2 shown in FIG. 6 is a transflective liquid crystal display panel in which reflecting regions 18 and transmitting regions 19 are provided to a liquid crystal layer 17. The display panel 2 is composed of color pixels whose color is determined by a color filter layer 20. Polarizing plates 16 are provided to the front and back surfaces of the display panel 2.

The operation of the liquid crystal display device of the above-described present embodiment will next be described. In this liquid crystal display device, the switching element 6 is in a transparent state when in the narrow-angle mode. At this time, collimated light corrected by the linear louver 11 is emitted from the display panel 2. Therefore, the display image cannot be recognized by an observer positioned at an angle from the front of the liquid crystal display device. The switching element 6 is in a scattering state when in the wide-angle mode. At this time, the collimated light from the linear louver 11 is scattered by the switching element 6. Accordingly, the light exiting the display panel 2 is scattered, the display light also reaches an observer positioned at an angle from the front of the liquid crystal display device, and this observer can recognize the display image.

The operation performed when switching from the wide-angle mode to the narrow-angle mode will next be described. When an operator selects the switching operation, the control unit 4, having received the corresponding operation signal, transmits a control signal to the switching element control unit 7 to cause the switching element 6 to perform the switching operation. Specifically, a voltage is applied to the switching element 6, and the switching element 6 is placed in the transparent state. The control unit 4 transmits a control signal to the light source control unit 3 so as to decrease the luminance of the planar light source 1. As a result, the display image can be given the same average luminance before and after switching. A control signal is also transmitted to the display control unit 5, and the contrast voltage for each color of pixels is reset. The frontal display image can thereby have the same hue before and after switching.

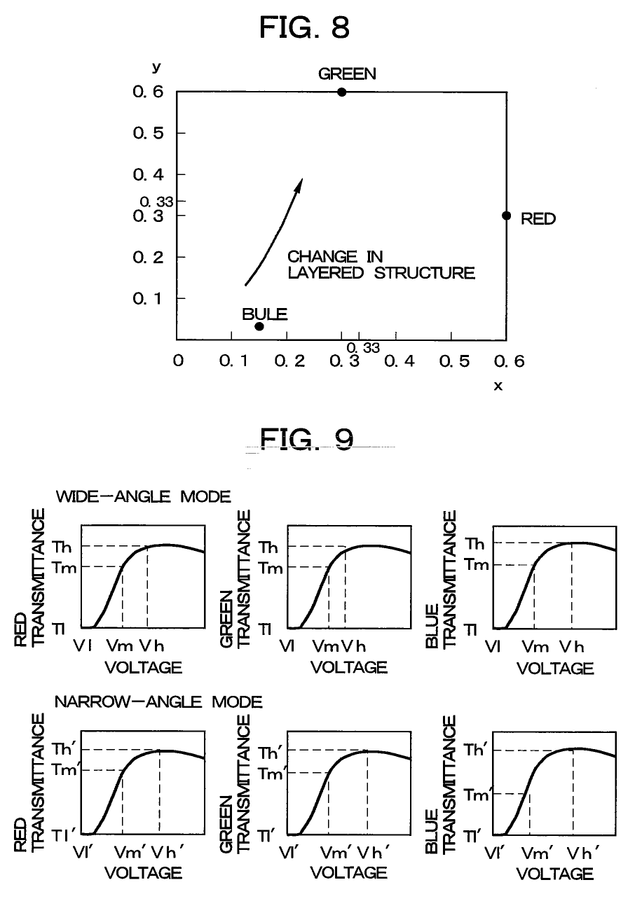

The variation of each hue will be described using FIGS. 3, 7, and 8. The chromaticity coordinates of the white LED 8 move backward as indicated by the arrow in FIG. 3 when the emission intensity decreases. The chromaticity coordinates also change as shown in FIG. 7 as a voltage is continuously applied to the polymer-dispersed liquid crystal 15. Accordingly, the layered structure as a whole exhibits the type of variation in chromaticity coordinates shown in FIG. 8. The light whose hue is changed as described above enters the display panel 2. The display image of the display panel 2 therefore assumes a yellow tinge. Accordingly, the contrast voltage of the display panel 2 is reset so that the maximum transmittance of red pixels and green pixels decreases, and the maximum transmittance of blue pixels increases, as shown in FIG. 9.

An extremely natural-looking image can thereby be obtained without variations in luminance and hue before and after switching between the wide-angle mode and the narrow-angle mode by the switching element 6.

In the present embodiment, plastic substrates 14 are used in the switching element 6. Superior mechanical durability is therefore obtained. Since this type of display device is often used in mobile or portable applications, an extremely thin design must be adopted to prevent the thickness of the liquid crystal display device from increasing. Creating polymer-dispersed liquid crystal on a plastic substrate is extremely advantageous when the display device is used in such applications.

There is no need to adjust the luminance of the planar light source 1 by using direct current in the embodiments described above. The type of light source hue variation shown in FIG. 3 is considered to be induced by temperature changes in the light source. Therefore, by temporally modulating the current so as to prevent a temperature increase, hue variation can be reduced, albeit not completely. A pulse is included as an example of the current waveform. Accordingly, it is also possible for the luminance of the planar light source 1 to be adjusted using a configuration in which the control unit 4 sets a pulse number, and the light source control unit 3 feeds a corresponding current pulse to the planar light source 1.

What is claimed is:

1. A liquid crystal display device having a switchable viewing angle, comprising:
a planar light source for emitting light in a plane;
a switching element for switching the collimated light to scattered light or collimated light;
a display panel for displaying an image; and
a control unit for controlling said switching element to switch between emitting scattered light or collimated light, varying the luminance of said planar light source during the switch, and adjusting the transmittance of at least a portion of the color pixels of said display panel in accordance with a variation in the luminance of said planar light source.

2. The liquid crystal display device having a switchable viewing angle according to claim 1, wherein said planar light source, said switching element and said display panel are layered in this order.

3. The liquid crystal display device having a switchable viewing angle according to claim 1, wherein said planar light source, said display panel and said switching element are layered in this order.

4. The liquid crystal display device having a switchable viewing angle according to claim 1, wherein said switching element is a polymer-dispersed liquid crystal.

5. The liquid crystal display device having a switchable viewing angle according to claim 1, wherein said switching element is a guest/host liquid crystal.

6. The liquid crystal display device having a switchable viewing angle according to claim 1, wherein the directivity of the light from said light source is increased by a linear louver.

7. The liquid crystal display device having a switchable viewing angle according to claim 1, wherein the color pixels for adjusting said transmittance are blue pixels.

8. The liquid crystal display device having a switchable viewing angle according to claim 1, wherein the color pixels for adjusting said transmittance are pixels of all colors, including blue, red, and green.

9. The liquid crystal display device having a switchable viewing angle according to claim 1, wherein the luminance of said planar light source is varied by varying the amount of electric current applied to said planar light source.

10. The liquid crystal display device having a switchable viewing angle according to claim 1, wherein the luminance of said planar light source is varied by time modulation of the current fed to said planar light source.

11. A method for switching the viewing angle of a liquid crystal display between wide-angle display and narrow-angle display by switching light from a planar light source or light from a display panel to scattered light or collimated light with the aid of a switching element when an image is displayed using light from said planar light source incident on said display panel; said method for switching the viewing angle of a liquid crystal display comprising:
varying the luminance of said planar light source during switching by said switching element;
adjusting the transmittance of at least a portion of the color pixels of said display panel in accordance with a variation in the luminance of said planar light source; and
performing control so that the variation in the luminance and hue does not occur before and after said switching.

12. The method for switching the viewing angle of a liquid crystal display according to claim 11, wherein said switching element switches to scattered light or collimated light by switching between a transparent state and a scattering state.

13. The method for switching the viewing angle of a liquid crystal display according to claim 11, wherein said switching element is switched to scattered light or collimated light by switching between a high-reflection state and a low-reflection state.

14. The method for switching the viewing angle of a liquid crystal display according to claim 11, wherein said switching element switches to scattered light or collimated light by switching between a high-absorption state and a low-absorption state.

15. A terminal device provided with the liquid crystal liquid crystal display device having a switchable viewing angle according to claim 1.
